(19) United States
(12) Patent Application Publication
(10) Pub. No.: US 2009/0016637 A1
(43) Pub. Date: Jan. 15, 2009

(54) ELECTRONIC APPLIANCE

(76) Inventors: Masato TAKEMOTO, Tokyo (JP); Shinji Nakamoto, Kanagawa (JP); Yasuyuki Hara, Kyoto (JP)

Correspondence Address: MCDERMOTT WILL & EMERY LLP, 600 13TH STREET, NW, WASHINGTON, DC, 20005-3096, US

(21) Appl. No.: 12/171,433

(22) Filed: Jul. 11, 2008

(30) Foreign Application Priority Data
Jul. 11, 2007 (JP) P.2007-182405

(51) Int. Cl. G06K 9/36; G10L 21/00

(52) U.S. Cl. 382/274; 704/201

(57) ABSTRACT

An electronic appliance is equipped with: a voice processing unit for executing one voice processing operation selected from plural sorts of voice processing operations; a zapping detecting unit for detecting a zapping condition; and a process switching unit for switching the presently executed voice processing operation to a different voice processing operation in response to a detection result for indicating whether or not the zapping condition is detected. When the zapping detecting unit detects the zapping condition, the process switching unit controls the voice processing unit to switch the presently executed voice processing operation to a voice processing operation which does not contain a sound quality improving function.

### BACKGROUND OF THE INVENTION

1. Field of the Invention

The present invention is related to an electronic appliance whose operation mode is switched to a proper operation mode in response to situations.

2. Description of the Related Art

As one of Japanese terrestrial digital broadcasting services (ISDB-T), a so-called “1seg” service has been provided with respect to portable telephones and mobile terminals. In the case that power supplies of broadcast receiving terminals capable of receiving television broadcast programs based upon the above-described “1seg” service are constructed of batteries, it is desirable that power consumption thereof is low in view of drive times of the broadcast receiving terminals. To this end, two voice reproducing modes, namely a normal mode and a power saving mode have been prepared for these broadcast receiving terminals. In the normal mode, the broadcast receiving terminals execute a function (will be referred to as “acoustic additional function” hereinafter) in order to realize superior sound qualities. In the power saving mode, since the broadcast receiving terminals do not execute the acoustic additional function, power consumption thereof is low, although sound qualities are deteriorated, as compared with those of the above-described normal mode.

In the above-described broadcast receiving terminals, in order to switch the voice reproducing modes, users are required to operate these broadcast receiving terminals. As a result, even under such a situation that the power saving modes are properly available, if the users do not execute the switching operation from the normal mode to the power saving mode, then the voice reproducing mode of the broadcast receiving terminals is still kept in the normal mode. As a consequence, it is desirable that even when voice reproducing modes of broadcast receiving terminals are not operated by users, the voice reproducing modes can be automatically switched.

### SUMMARY OF THE INVENTION

An object of the present invention is to provide an electronic appliance capable of switching a voice reproducing mode thereof to a proper mode in response to situations even when the power mode switching operation is not executed by a user.

The present invention is to provide an electronic appliance comprising: a voice processing unit for executing one voice processing operation selected from plural sorts of voice processing operations; a zapping detecting unit for detecting a zapping condition; and a process switching unit for switching the presently executed voice processing operation to a different voice processing operation in response to a detection result for indicating whether or not the zapping condition is detected; in which when the zapping detecting unit detects the zapping condition, the process switching unit controls the voice processing unit to switch the presently executed voice processing operation to a voice processing operation which does not contain a sound quality improving function.

The present invention is to provide an electronic appliance comprising: an image processing unit for executing one image processing operation selected from plural sorts of image processing operations; a zapping detecting unit for detecting a zapping condition; and a process switching unit for switching the presently executed image processing operation to a different image processing operation in response to a detection result for indicating whether or not the zapping condition is detected; in which when the zapping detecting unit detects the zapping condition, the process switching unit controls the image processing unit to switch the presently executed image processing operation to an image processing operation which does not contain an image quality improving function.

The present invention is to provide an electronic appliance comprising: a voice processing unit for executing one voice processing operation selected from plural sorts of voice processing operations; a judging unit for judging whether a signal transmission path defined from the voice processing unit up to a voice output unit corresponds to a wired signal transmission path, or a wireless signal transmission path; and a process switching unit for switching the presently executed voice processing operation to a different voice processing operation in response to a judgement result of the signal transmission path; in which when the signal transmission path is the wired signal transmission path, the process switching unit controls the voice processing unit to switch the presently executed voice processing operation to a voice processing operation which contains a sound quality improving function, whereas when the signal transmission path is the wireless signal transmission path, the process switching unit controls the voice processing unit to switch the presently executed voice processing operation to a voice processing operation which does not contain the sound quality improving function.

The present invention is to provide an electronic appliance comprising: a voice processing unit for executing one voice processing operation selected from plural sorts of voice processing operations; an information acquiring unit for acquiring genre information about contents which are processed by the voice processing unit; and a process switching unit for switching the presently executed voice processing operation to a different voice processing operation in response to the genre information acquired by the information processing unit; in which the plural sorts of voice processing operations include a voice processing operation which contains a sound quality improving function, and another voice processing operation which does not contain the sound quality improving function.

The present invention is to provide an electronic appliance comprising: a voice processing unit for executing one voice processing operation selected from plural sorts of voice processing operations; a sound volume measuring unit for measuring a surrounding sound volume; and a process switching unit for switching the presently executed voice processing operation in response to information related to the surrounding sound volume measured by the sound volume measuring unit; in which when the measured surrounding sound volume is lower than a reference value, the process switching unit controls the voice processing unit to switch the presently executed voice processing operation to a voice processing operation which contains a sound quality improving function.

The present invention is to provide an electronic appliance comprising: an image processing unit for executing one image processing operation selected from plural sorts of image processing operations; a luminance detecting unit for detecting surrounding luminance; and a process switching unit for switching the presently executed image processing operation to a different image processing operation in response to information related to the surrounding luminance detected by the luminance detecting unit; in which when the detected surrounding luminance is lower than a reference value, the process switching unit controls the image processing unit to switch the presently executed image processing operation to an image processing operation which contains an image quality improving function.

The present invention is to provide an electronic appliance comprising: a key operating unit; an image processing unit for executing one image processing operation selected from plural sorts of image processing operations; a key operation detecting unit for detecting a time interval of key input operations with respect to the key operating unit; and a process switching unit for switching the presently executed image processing operation to a different image processing operation in response to the time interval of the key input operations detected by the key operation detecting unit; in which when the detected time interval of the key input operations is longer than, or equal to a reference value, the process switching unit controls the image processing unit to switch the presently executed image processing operation to an image processing operation which contains an image quality improving function.

The present invention is to provide an electronic appliance comprising: two housings which can be opened and closed with each other; an image processing unit for executing one image processing operation selected from plural sorts of image processing operations; a condition detecting unit for detecting open/close conditions of the two housings; and a process switching unit for switching the presently executed image processing operation to a different image processing operation in response to a condition detected by the condition detecting unit; in which when the two housings are under open condition, the process switching unit controls the image processing unit to switch the presently executed image processing operation to an image processing operation which contains an image quality improving function.

The present invention is to provide an electronic appliance comprising: a voice processing unit for executing one voice processing operation selected from plural sorts of voice processing operations; a data broadcast processing unit for executing a processing operation in order to display a data broadcasting content; and a process switching unit for switching the presently executed voice process operation to a different voice process operation in response to a situation for indicating whether or not the data broadcast processing unit performs the digital broadcasting content display processing operation; in which when the data broadcast processing unit does not execute the digital broadcasting content display processing operation, the process switching unit controls the voice processing unit to switch the presently executed voice processing operation to a voice processing operation which contains a sound quality improving function.

The present invention is to provide an electronic appliance comprising: a receiving unit for receiving a wireless signal; a reception strength detecting unit for detecting an electromagnetic wave reception strength of a wireless signal received by the receiving unit; an image processing unit for executing an image processing operation; a voice processing unit for executing a voice processing operation; and a process switching unit for switching the image processing operation and the sound processing operation in response to an electromagnetic wave reception strength detected by the reception strength detecting unit; in which when the electromagnetic wave reception strength detected by the reception strength detecting unit is larger than, or equal to a reference value, the process switching unit controls both the image processing unit and the voice processing unit so as to execute both the image processing operation and the voice processing operation.

The present invention is to provide an electronic appliance comprising: an image processing unit for executing one image processing operation selected from plural sorts of image processing operations; a noise detecting unit for detecting a noise strength indicative of a situation of an error occurred when a decoding operation is carried out by the image processing unit; and a process switching unit for switching the presently executed image, process operation to a different image processing operation in response to a noise strength detected by the noise detecting unit; in which when the noise strength detected by the noise detecting unit is smaller than a reference value, the process switching unit controls the image processing unit to switch the presently executed image processing operation to an image processing operation which contains an image quality improving function.

The present invention is to provide an electronic appliance comprising: a voice communication processing unit for performing a voice communication processing operation by utilizing a wireless signal; a voice processing unit for executing one voice processing operation selected from plural sorts of voice processing operations; and a process switching unit for switching the presently executed voice processing operation to a different voice processing operation in response to a situation for indicating whether or not the voice communication processing unit performs the voice communication processing operation; in which when the voice communication processing unit does not perform the voice communication processing operation, the process switching unit controls the voice processing unit to switch the presently executed voice processing operation to a voice processing operation which contains a sound quality improving function.

The present invention is to provide a process switching program for causing a computer to function as the respective units comprised in the above-described electronic appliance.

In accordance with the electronic appliance and the process switching programs, related to the present invention, the optimum power modes can be used in response to the situations, while the power mode switching instructions are not issued from the users.

### BRIEF DESCRIPTION OF THE DRAWINGS

FIG. 1 is a block diagram for showing a broadcast receiving terminal of a first embodiment mode of the present invention.

FIG. 2 is a block diagram for indicating an internal arrangement of the broadcast receiving terminal of the first embodiment mode.

FIG. 3 is a block diagram for representing a voice processing unit employed in the broadcast receiving terminal of the first embodiment mode.

FIG. 4 is a block diagram for showing an image processing unit employed in the broadcast receiving terminal of the first embodiment mode.

FIG. 5 is a flow chart for describing operations of the broadcast receiving terminal of the first embodiment mode.

FIG. 6 is a flow chart for describing operations of the broadcast receiving terminal of the first embodiment mode.

FIG. 7 is a block diagram for showing a broadcast receiving terminal of a second embodiment mode according to the present invention.

FIG. 8 is a block diagram for representing an internal arrangement of the broadcast receiving terminal of the second embodiment mode.

FIG. 9 is a flow chart for describing operations of the broadcast receiving terminal of the second embodiment mode.

FIG. 10 is a block diagram for showing a broadcast receiving terminal of a third embodiment mode according to the present invention.

FIG. 11 is a block diagram for representing an internal arrangement of the broadcast receiving terminal of the third embodiment mode.

FIG. 12 is a flow chart for describing operations of the broadcast receiving terminal of the third embodiment mode.

FIG. 13 is a block diagram for showing a broadcast receiving terminal of a fourth embodiment mode according to the present invention.

FIG. 14 is a block diagram for representing an internal arrangement of the broadcast receiving terminal of the fourth embodiment mode.

FIG. 15 is a flow chart for describing operations of the broadcast receiving terminal of the fourth embodiment mode.

FIG. 16 is a block diagram for showing a broadcast receiving terminal of a fifth embodiment mode according to the present invention.

FIG. 17 is a block diagram for representing an internal arrangement of the broadcast receiving terminal of the fifth embodiment mode.

FIG. 18 is a flow chart for describing operations of the broadcast receiving terminal of the fifth embodiment mode.

FIG. 19 is a block diagram for showing a broadcast receiving terminal of a sixth embodiment mode according to the present invention.

FIG. 20 is a block diagram for representing an internal arrangement of the broadcast receiving terminal of the sixth embodiment mode.

FIG. 21 is a flow chart for describing operations of the broadcast receiving terminal of the sixth embodiment mode.

FIG. 22 is a block diagram for showing a broadcast receiving terminal of a seventh embodiment mode according to the present invention.

FIG. 23 is a block diagram for representing an internal arrangement of the broadcast receiving terminal of the seventh embodiment mode.

FIG. 24 is a flow chart for describing operations of the broadcast receiving terminal of the seventh embodiment mode.

FIG. 25 is a block diagram for showing a broadcast receiving terminal of an eighth embodiment mode according to the present invention.

FIG. 26 is a block diagram for representing an internal arrangement of the broadcast receiving terminal of the eighth embodiment mode.

FIG. 27 is a flow chart for describing operations of the broadcast receiving terminal of the eighth embodiment mode.

FIG. 28 is a block diagram for showing a broadcast receiving terminal of a ninth embodiment mode according to the present invention.

FIG. 29 is a block diagram for representing an internal arrangement of the broadcast receiving terminal of the ninth embodiment mode.

FIG. 30 is a flow chart for describing operations of the broadcast receiving terminal of the ninth embodiment mode.

FIG. 31 is a flow chart for describing operations of a broadcast receiving terminal of a tenth embodiment mode.

FIG. 32 is a block diagram for showing a broadcast receiving terminal of an eleventh embodiment mode according to the present invention.

FIG. 33 is a block diagram for representing an internal arrangement of the broadcast receiving terminal of the eleventh embodiment mode.

FIG. 34 is a flow chart for describing operations of the broadcast receiving terminal of the eleventh embodiment mode.

### DESCRIPTION OF THE PREFERRED EMBODIMENTS

Referring now to drawings, a description is made of embodiment modes of the present invention.

### First Embodiment Mode

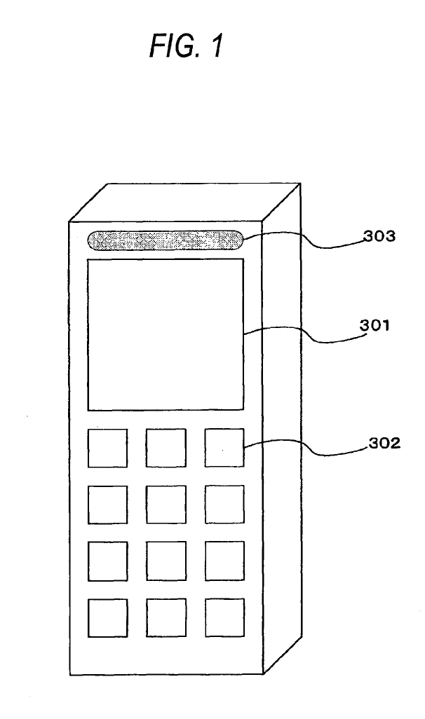

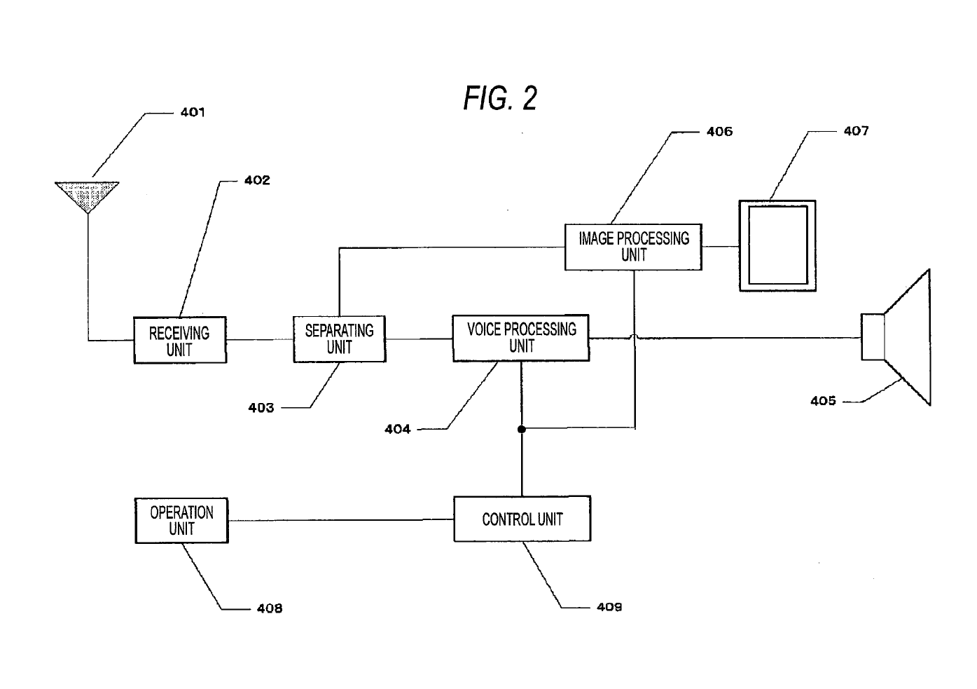

FIG. 1 is a block diagram for showing a broadcast receiving terminal according to a first embodiment mode of the present invention. As represented in FIG. 1, the broadcast receiving terminal of the first embodiment mode is equipped with an image display unit 301, an operation unit 302 of a channel selecting operation, and a speaker 303. FIG. 2 is a block diagram for representing an internal arrangement of the broadcast receiving terminal of the first embodiment mode. As represented in FIG. 2, the broadcast receiving terminal of the first embodiment mode is equipped with an antenna 401, a receiving unit 402, a separating unit 403, a voice processing unit 404, a speaker 405, an image processing unit 406, an image display unit 407, a control unit 409, and the operation unit 302.

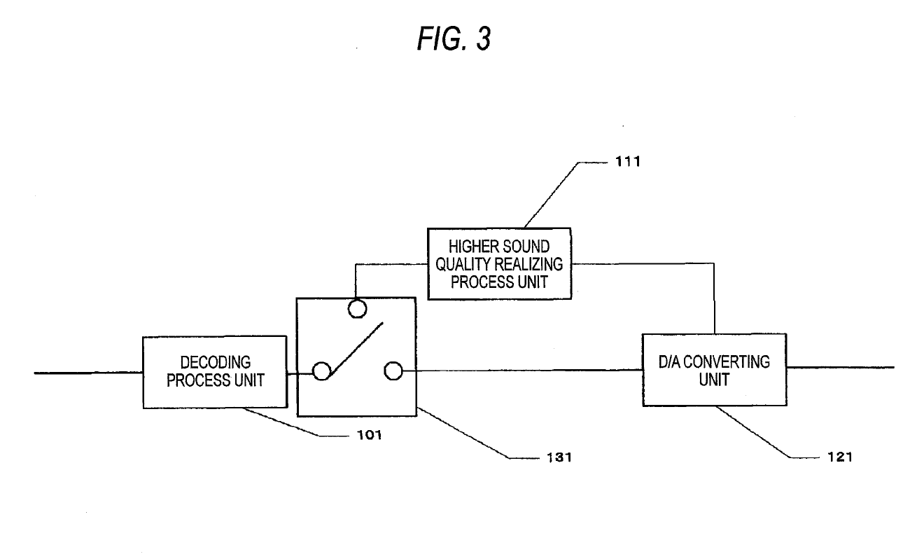

FIG. 3 is a block diagram for showing an internal arrangement of the voice processing unit 404 employed in the broadcast receiving terminal of the first embodiment mode. With respect to voice data entered to the voice processing unit 404, a decoding process operation is carried out in a decoding process unit 101. Thereafter, a switching operation is carried out in a sound quality switching unit 131 as to whether or not a process operation by a higher sound quality realizing process unit 111 is executed. In the case that the process operation by the higher sound quality realizing process unit 111 is not carried out, power consumption of the broadcast receiving terminal can be suppressed, as compared with power consumption made in such a case that the process operation by the higher sound quality realizing process unit 111 is not executed. Thereafter, the processed voice data is converted into analog data by a D/A converting unit 121.

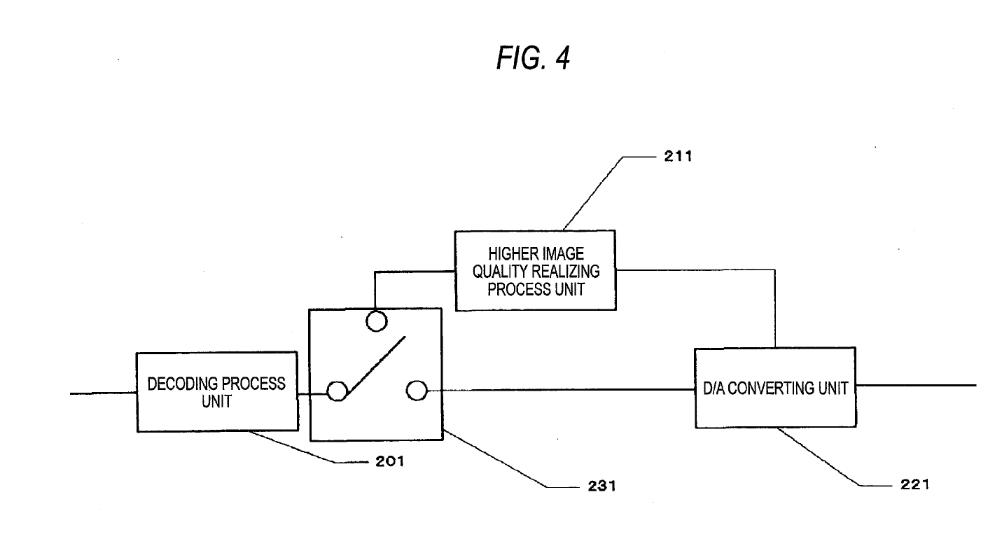

FIG. 4 is a block diagram for showing an internal arrangement of the image processing unit 406 employed in the broadcast receiving terminal of the first embodiment mode. With respect to image data entered to the image processing unit 406, a decoding process operation is carried out in a decoding process unit 201. Thereafter, a switching operation is carried out in an image quality switching unit 231 as to whether or not a process operation by a higher image quality realizing process unit 211 is executed. In the case that the process operation by the higher image quality realizing process unit 211 is not carried out, power consumption of the broadcast receiving terminal can be suppressed, as compared with power consumption made in such a case that the process operation by the higher image quality realizing process unit 211 is not executed. Thereafter, the processed image data is converted into analog data by a D/A converting unit 221.

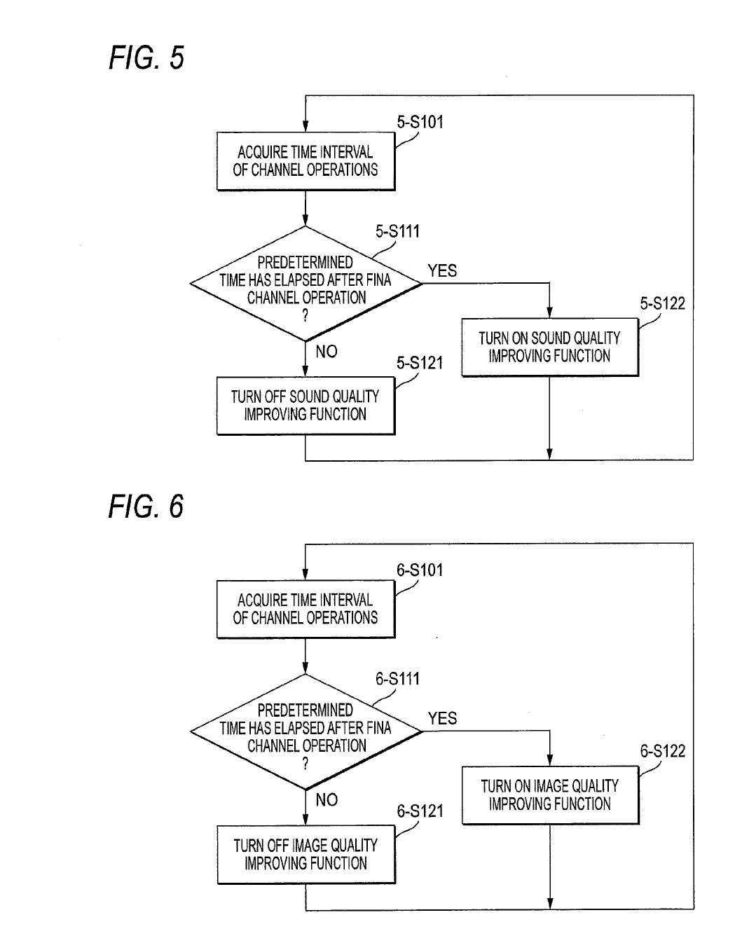

FIG. 5 is a flow chart for describing operations of the broadcast receiving terminal of the first embodiment mode. As shown in FIG. 5, the control unit 409 detects a time interval of channel switching operations performed by employing the operation unit 302 (step 5-S101), and then compares the detected channel switching time interval with a reference value (step 5-S111). In the case that the channel switching time interval is shorter than the reference value, the control unit 409 judges that this condition corresponds to a so-called “zapping condition”, and thus, turns OFF a sound quality improving function (step 5-S121). On the other hand, in the case that the channel switching time interval is longer than, or equal to the reference value, the control unit 409 judges that this condition does not correspond to the above-described “zapping condition”, and thus, turns ON the sound quality improving function (step 5-S122). It should be understood that the above-explained process operations executed by the control unit 409 may be alternatively realized by employing software.

FIG. 6 is a flow chart for describing operations of the broadcast receiving terminal of the first embodiment mode. As shown in FIG. 6, the control unit 409 detects a time interval of channel switching operations performed by employing the operation unit 302 (step 6-S101), and then, compares the detected channel switching time interval with a reference value (step 6-S1). In the case that the channel switching time interval is shorter than the reference value, the control unit 409 judges that this condition corresponds to the “zapping condition”, and thus, turns OFF: an image quality improving function (step 6-S124). On the other hand, in the case that the channel switching time interval is longer than, or equal to the reference value, the control unit 409 judges that this condition does not correspond to the above-described “zapping condition”, and thus, turns ON the image quality improving function (step 6-S122). It should also be understood that the above-explained process operations executed by the control unit 409 may be alternatively realized by employing software.

It should also be understood that a “zapping” operation implies that a tuning operation of broadcasting programs, or a selecting operation of recorded contents is carried out in a restless manner. In other words, such an operation condition that channels are switched in a continuous manner within a short time, or contents are switched in a continuous manner within a short time corresponds to a so termed “zapping condition.”

### Second Embodiment Mode

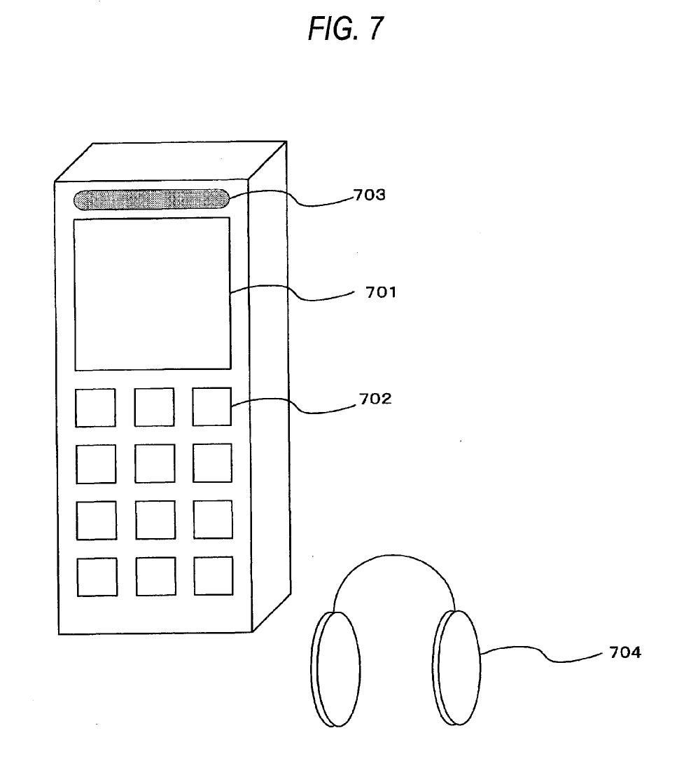

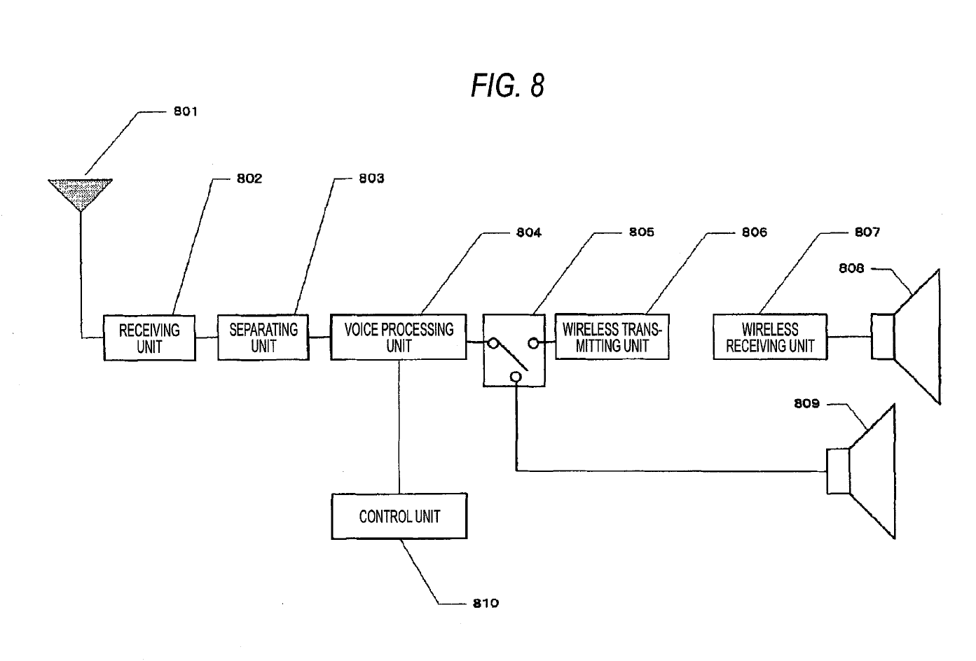

FIG. 7 is a block diagram for indicating a broadcast receiving terminal according to a second embodiment mode of the present invention. As indicated in FIG. 7, the broadcast receiving terminal of the second embodiment mode is equipped with an image display unit 701, a switch 702, a speaker 703, and a wireless type headphone 704. FIG. 8 is a block diagram for representing an internal arrangement of the broadcast receiving terminal of the second embodiment mode. As shown in FIG. 8, the broadcast receiving terminal of the second embodiment mode is equipped with an antenna 801, a receiving unit 802, a separating unit 803, a voice processing unit 804, a wired/wireless transmission switching unit 805, a wireless transmitting unit 806, a wireless receiving unit 807, a speaker 808, another speaker 809, and a control unit 810.

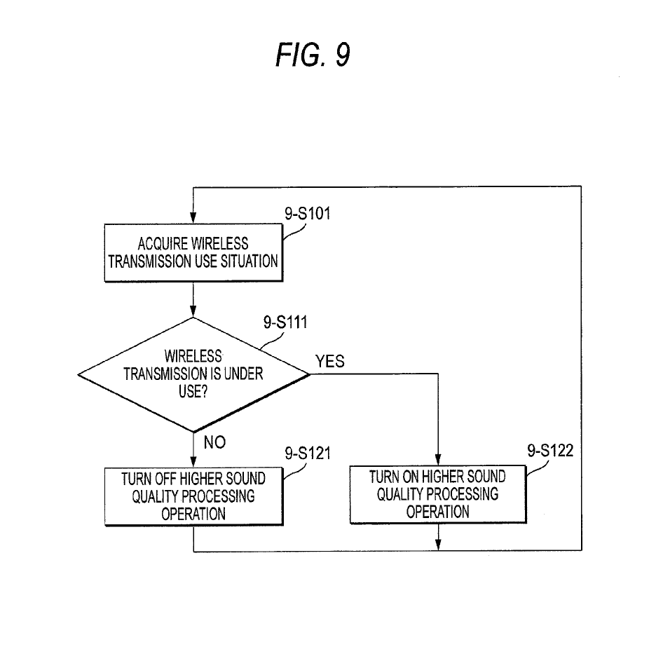

FIG. 9 is a flow chart for describing operations of the broadcast receiving terminal of the second embodiment mode. As shown in FIG. 9, the control unit 810 judges whether or not a signal transmission path defined from the voice processing unit 804 up to the speaker 808, or 809 based upon a status of the wired/wireless transmission switching unit 805 (step 9-S111). In the case that the signal transmission path is the wireless transmission path, the control unit 810 turns OFF the sound quality improving function (step 9-S121). On the other hand, in the case that the signal transmission path is the wired transmission path, the control unit 810 turns ON the sound quality improving function (step 9-S122). It should also be understood that the above-explained process operations executed by the control unit 810 may be alternatively realized by employing software.

### Third Embodiment Mode

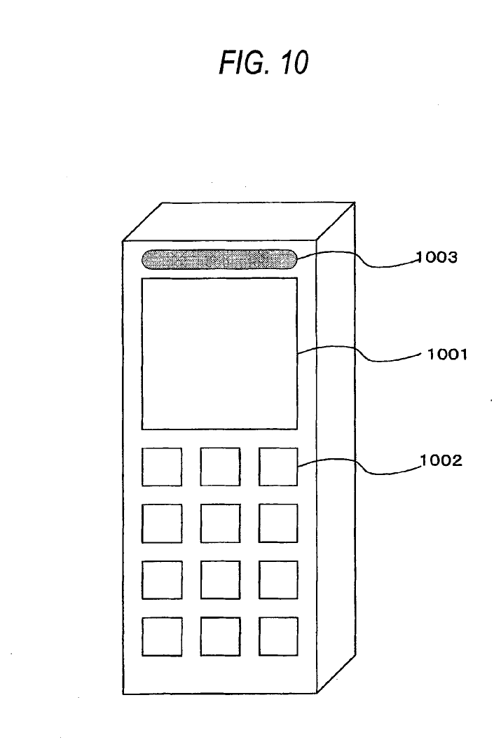

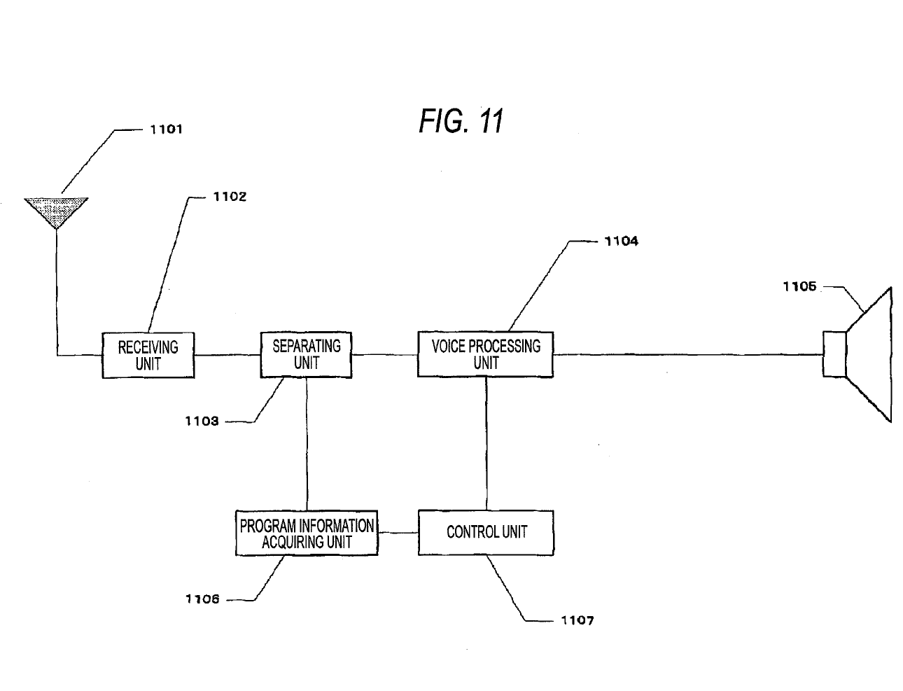

FIG. 10 is a block diagram for indicating a broadcast receiving terminal according to a third embodiment mode of the present invention. As indicated in FIG. 10, the broadcast receiving terminal of the third embodiment mode is equipped with an image display unit 1001, a switch 1002, and a speaker 1003. FIG. 11 is a block diagram for representing an internal arrangement of the broadcast receiving terminal of the third embodiment mode. As shown in FIG. 11, the broadcast receiving terminal of the third embodiment mode is equipped with an antenna 1101, a receiving unit 1102, a separating unit 1103, a voice processing unit 1104, a speaker 1105, a program information acquiring unit 1106, and a control unit 1107.

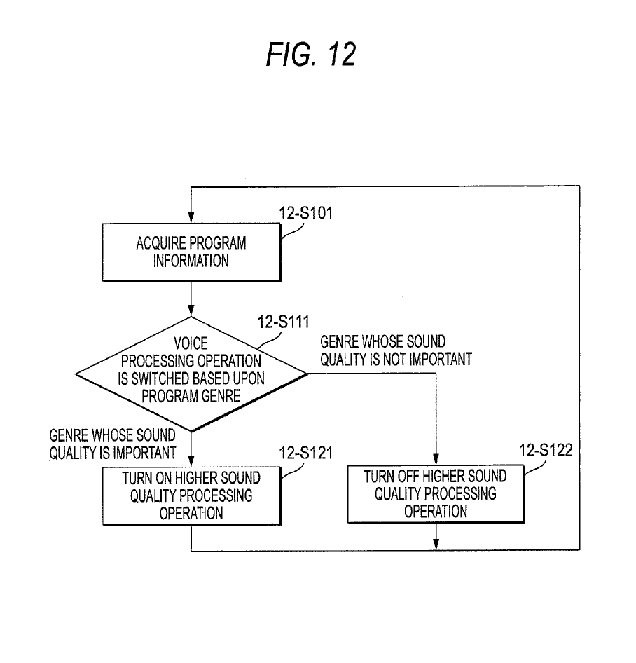

FIG. 12 is a flow chart for describing operations of the broadcast receiving terminal of the third embodiment mode. As shown in FIG. 12, the control unit 1107 acquires program information (step 12-S101), and then, switches the voice processing operations in response to genre of a program which is indicated by this acquired program information (step 12-S111). In such a genre case that the sound quality thereof is not important, the control unit 1107 turns OFF the sound quality improving function (step 12-S121). On the other hand, in such a genre case that the sound quality thereof is important, the control unit 1107 turns ON the sound quality improving function (step 12-S122). It should also be understood that the above-explained process operations executed by the control unit 1107 may be alternatively realized by employing—software.

### Fourth Embodiment Mode

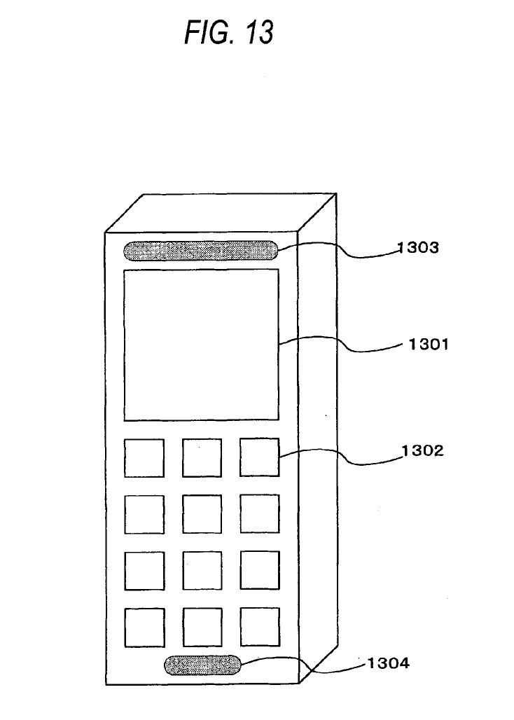

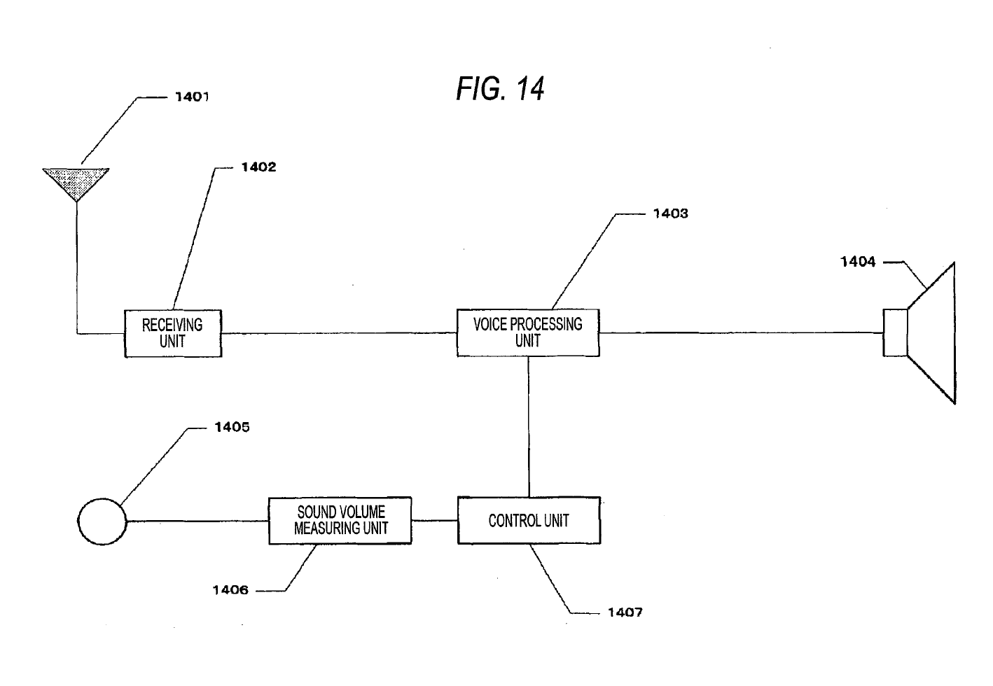

FIG. 13 is a block diagram for indicating a broadcast receiving terminal according to a fourth embodiment mode of the present invention. As indicated in FIG. 13, the broadcast receiving terminal of the fourth embodiment mode is equipped with an image display unit 1301, a switch 1302, a speaker 1303, and a microphone 1304. FIG. 14 is a block diagram for representing an internal arrangement of the broadcast receiving terminal of the fourth embodiment mode. As shown in FIG. 14, the broadcast receiving terminal of the fourth embodiment mode is equipped with an antenna 1401, a receiving unit 1402, a voice processing unit 1403, a speaker 1104, a microphone 1405, a sound volume measuring unit 1406, and a control unit 1407.

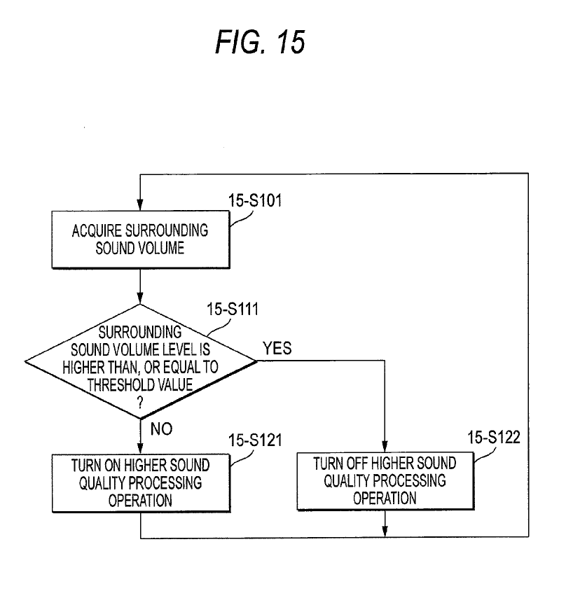

FIG. 15 is a flow chart for describing operations of the broadcast receiving terminal of the fourth embodiment mode. As shown in FIG. 15, the control unit 1407 acquires information related to a surrounding sound volume measured by the sound volume measuring unit 1406 (step 15-S101), and then switches voice processing operations in response to the acquired surrounding sound volume (step 15-S111). In the case that the surrounding sound volume is longer than, or equal to a reference value, the control unit 1107 turns OFF a higher sound volume function (step 15-S121). On the other hand, in the case that the surrounding sound volume is small than the reference value, the control unit 1107 turns ON the higher sound volume function (step 15-S122). It should also be understood that the above-explained process operations executed by the control unit 1407 may be alternatively realized by employing software.

### Fifth Embodiment Mode

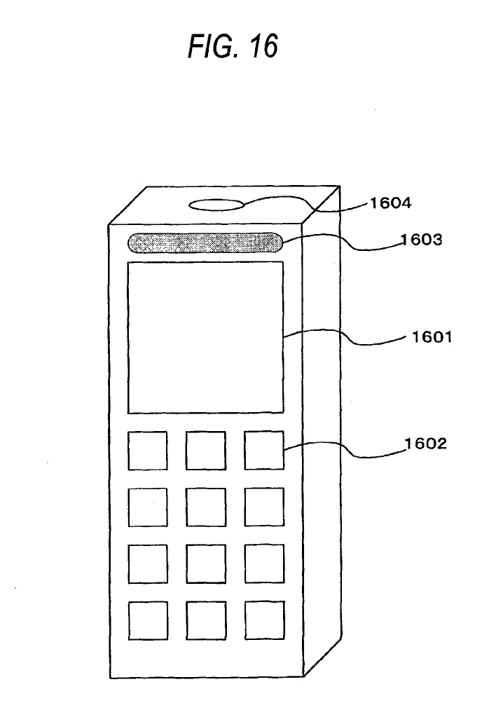

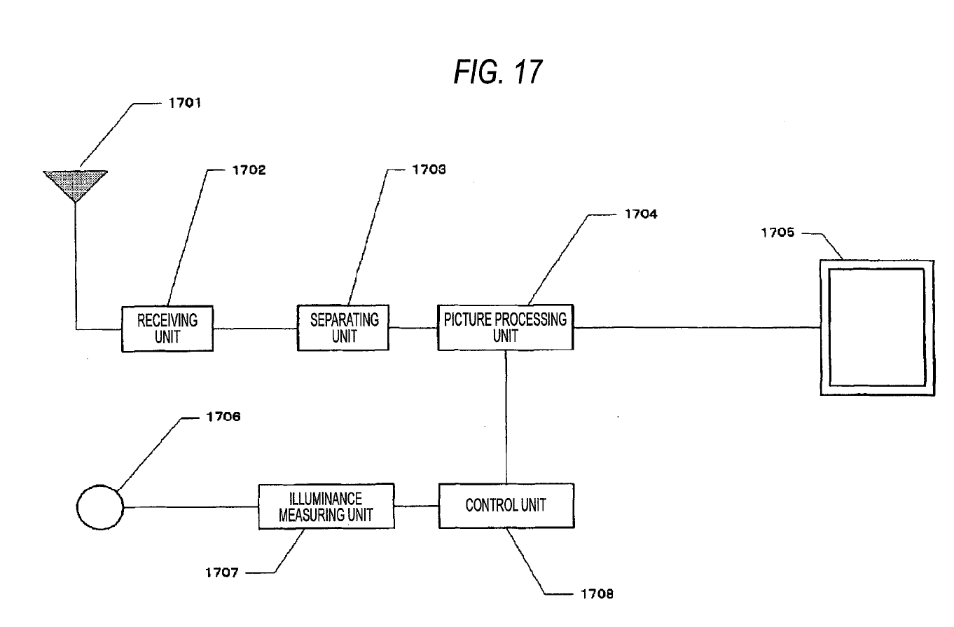

FIG. 16 is a block diagram for indicating a broadcast receiving terminal according to a fifth embodiment mode of the present invention. As indicated in FIG. 16, the broadcast receiving terminal of the fifth embodiment mode is equipped with an image display unit 1601, a switch 1602, a speaker 1603, and an optical sensor 1604. FIG. 17 is a block diagram for representing an internal arrangement of the broadcast receiving terminal of the fifth embodiment mode. As shown in FIG. 17, the broadcast receiving terminal of the fifth embodiment mode is equipped with an antenna 1701, a receiving unit 1702, a separating unit 1703, a picture processing unit 1704, an image display unit 1705, an optical sensor 1706, an illuminance measuring unit 1707, and a control unit 1708.

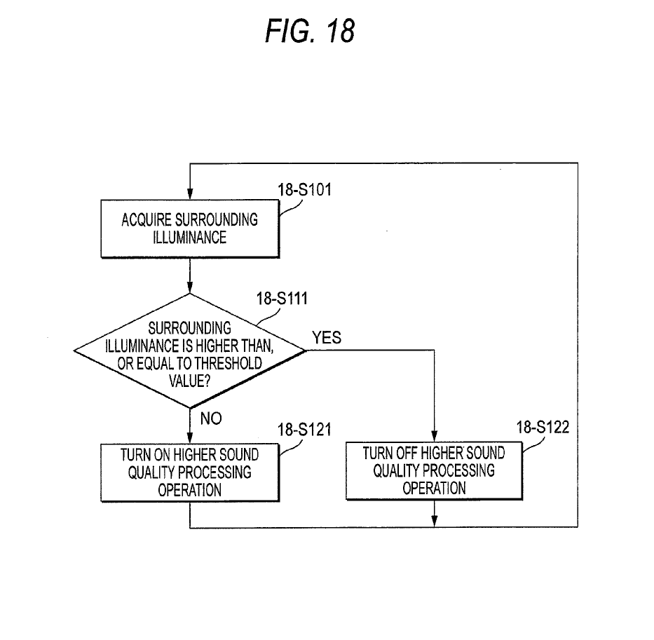

FIG. 18 is a flow chart for describing operations of the broadcast receiving terminal of the fifth embodiment mode. As shown in FIG. 18, the control unit 1708 acquires information related to surrounding illuminance detected by the optical sensor 1604 (step 18-S101), and then switches image filtering process operations in response to the acquired surrounding illuminance (step 18-S111). In the case that the surrounding illuminance is higher than, or equal to a reference value, the control unit 1708 turns OFF the image filtering process operation (step 18-S122). On the other hand, in the case that the surrounding illuminance is lower than the reference value, the control unit 1708 turns ON the image filtering process operation (step 18-S121). It should also be understood that the above-explained process operations executed by the control unit 1708 may be alternatively realized by employing software.

### Sixth Embodiment Mode

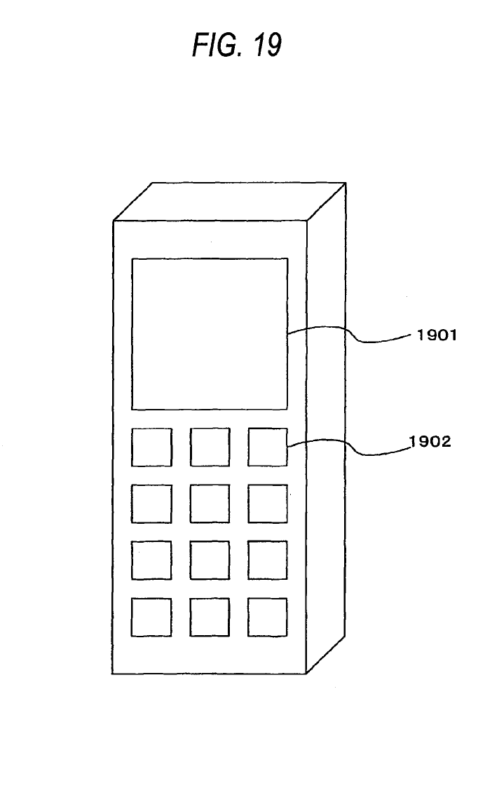

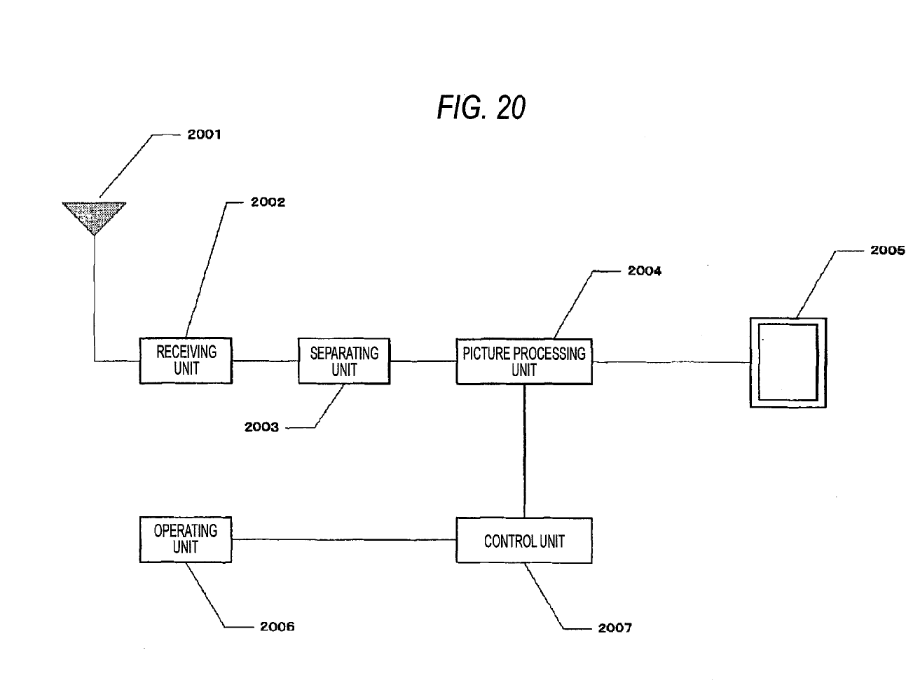

FIG. 19 is a block diagram for showing a broadcast receiving terminal according to a sixth embodiment mode of the present invention. As represented in FIG. 19, the broadcast receiving terminal of the sixth embodiment mode is equipped with an image display unit 1901, and a key 1902. FIG. 20 is a block diagram for representing an internal arrangement of the broadcast receiving terminal of the sixth embodiment mode. As represented in FIG. 20, the broadcast receiving terminal of the sixth embodiment mode is equipped with an antenna 2001, a receiving unit 2002, a separating unit 2003, an image processing unit 2004, an image display unit 2005, a control unit 2007, and the key 1902.

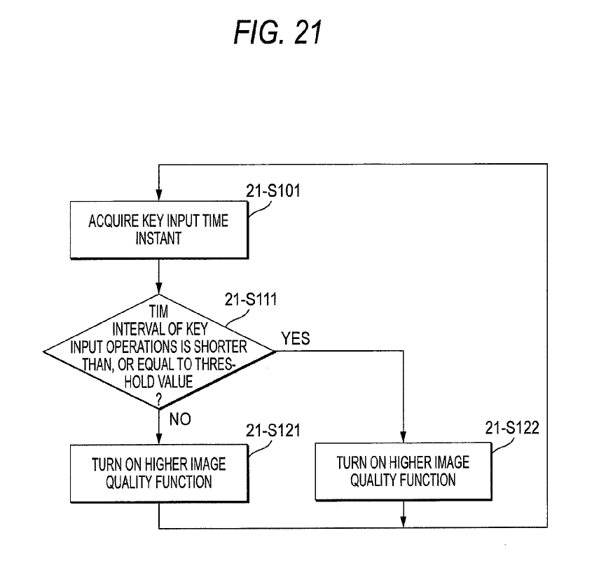

FIG. 21 is a flow chart for describing operations of the broadcast receiving terminal of the sixth embodiment mode. As shown in FIG. 21, the control unit 2007 detects a time interval of inputting operations performed by operating the key 1902 (step 21-S101), and then compares the detected key input time interval with a reference value (step 21-S111). In the case that the key input time interval is longer than, or equal to the reference value, the control unit 2007 turns ON the higher image quality function (step 21-S121). On the other hand, in the case that the key input time interval is shorter than the reference value, the control unit 2007 turns OFF the higher image quality function (step 21-S122). It should also be understood that the above-explained process operations executed by the control unit 2007 may be alternatively realized by employing software.

### Seventh Embodiment Mode

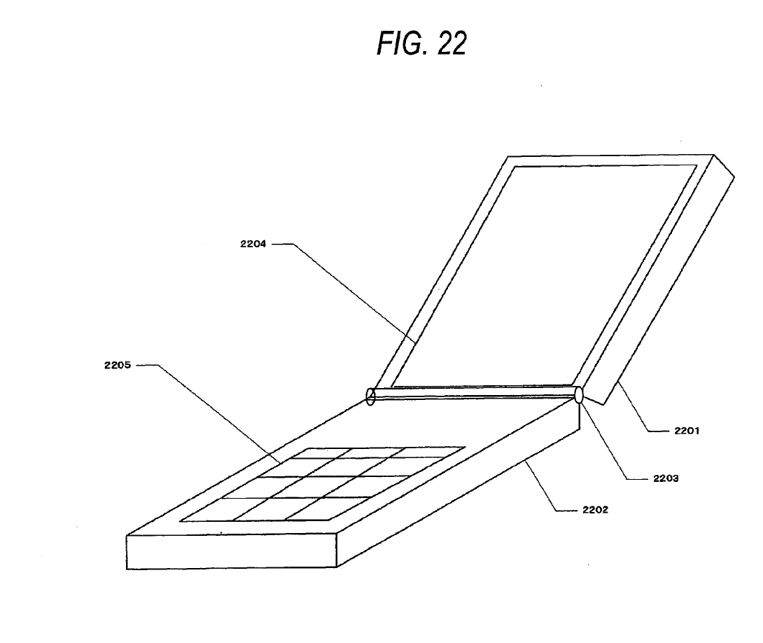

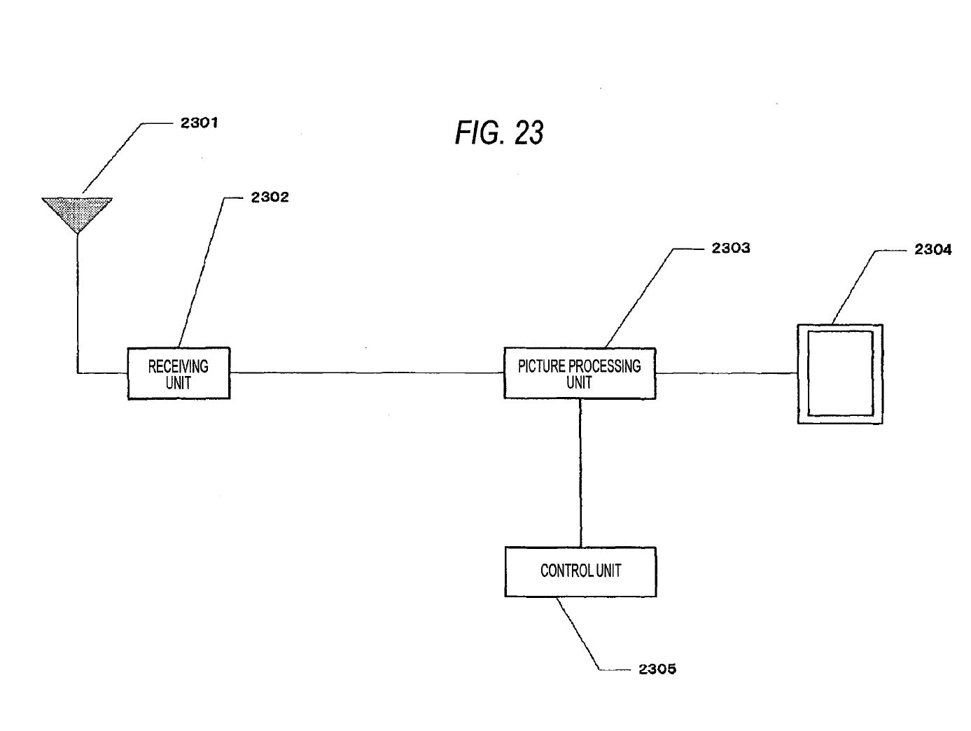

FIG. 22 is a block diagram for indicating a broadcast receiving terminal according to a seventh embodiment mode of the present invention. As indicated in FIG. 22, the broadcast receiving terminal of the seventh embodiment mode is equipped with a first housing 2201, a second housing 2202, a hinge portion 2203 which joins the first housing 2201 to the second housing 2202, an image display unit 2204, and a key 2205. FIG. 23 is a block diagram for representing an internal arrangement of the broadcast receiving terminal of the seventh embodiment mode. As shown in FIG. 23, the broadcast receiving terminal of the seventh embodiment mode is equipped with an antenna 2301, a receiving unit 2302, an image processing unit 2303, an image display unit 2304, and a control unit 2305

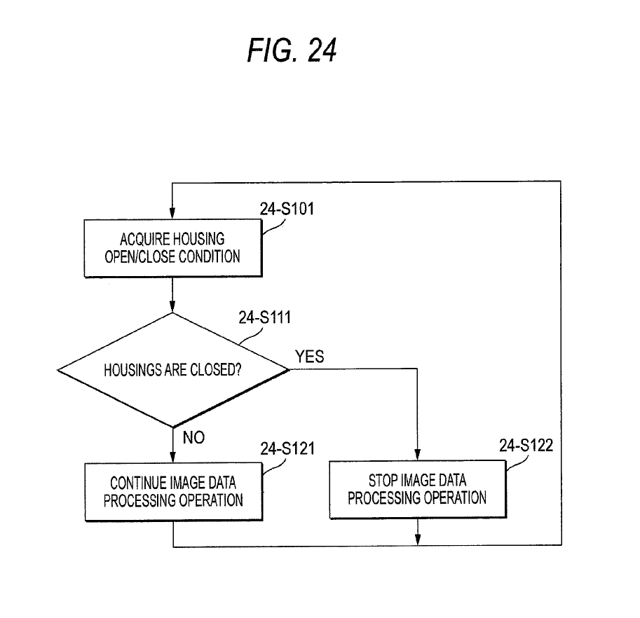

FIG. 24 is a flow chart for describing operations of the broadcast receiving terminal of the seventh embodiment mode. As shown in FIG. 24, the control unit 2305 detects open/close conditions of the first/second housings 2201/2202 (step 24-S101), and then switches image processing operations in response to the open/close conditions of the first/second housings 2201/2202 (step 24-S111). In the case that the first/second housings 2201/2202 are opened, the control unit 2305 turns ON the higher image quality function (step 24-S121). On the other hand, in the case that the first/second housings 2201/2202 are closed, the control unit 2305 turns OFF the higher image quality function (step 24-S122). It should also be understood that the above-explained process operations executed by the control unit 2305 may be alternatively realized by employing software.

### Eighth Embodiment Mode

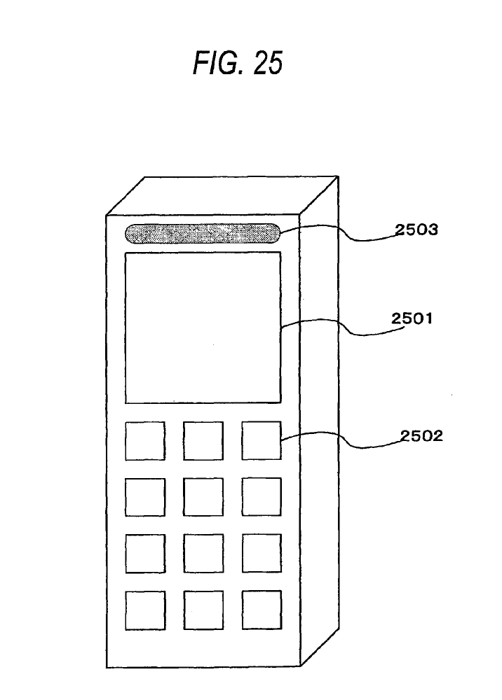

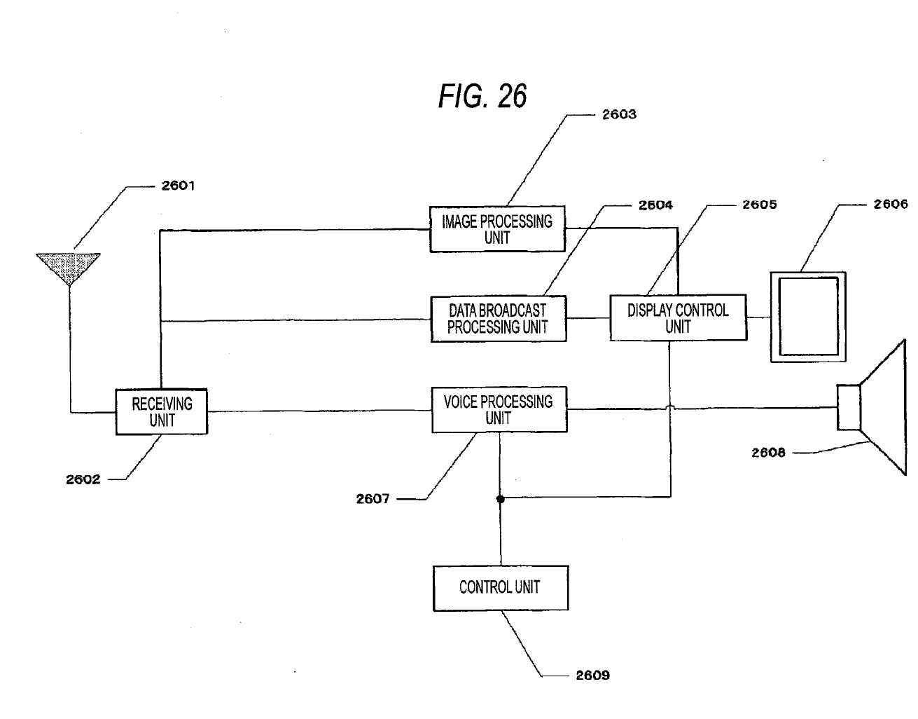

FIG. 25 is a block diagram for showing a broadcast receiving terminal according to an eighth embodiment mode of the present invention. As represented in FIG. 25, the broadcast receiving terminal of the eighth embodiment mode is equipped with an image display unit 2501, a key 2502, and a speaker 2503. FIG. 26 is a block diagram for representing an internal arrangement of the broadcast receiving terminal of the eighth embodiment mode. As represented in FIG. 26, the broadcast receiving terminal of the eighth embodiment mode is equipped with an antenna 2601, a receiving unit 2602, an image processing unit 2603, a data broadcast processing unit 2604, a display control unit 2605, an image display unit 2606, a voice processing unit 2607, a speaker 2608, and a control unit 2609.

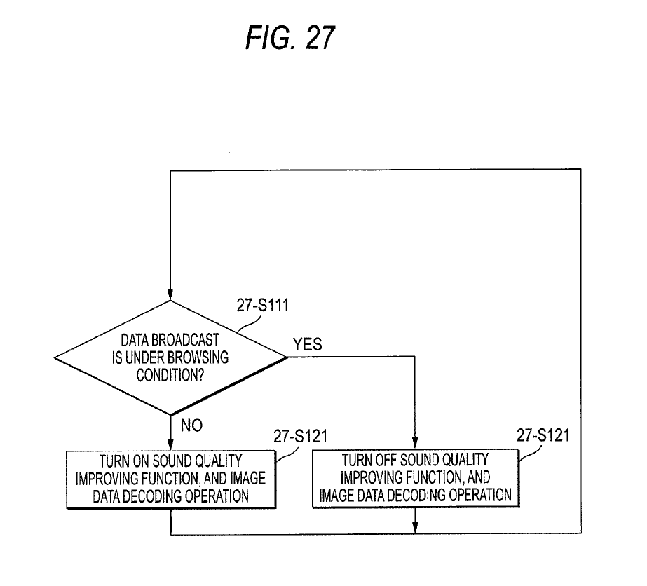

FIG. 27 is a flow chart for describing operations of the broadcast receiving terminal of the eighth embodiment mode. As shown in FIG. 27, the control unit 2609 switches image processing operations in response to browsing of data broadcast (step 27-S111). In such a case that the data broadcast is not browsed, the control unit 2609 turns ON the higher sound quality function, and also, executes the decoding process operation of the image data (step 27-S121). On the other hand, in such a case that the data broadcast is being browsed, the control unit 2609 turns OFF the higher sound quality function, and also, stops the decoding process operation of the image data (step 27-S122). It should also be understood that the above-explained process operations executed by the control unit 2609 may be alternatively realized by employing-software.

### Ninth Embodiment Mode

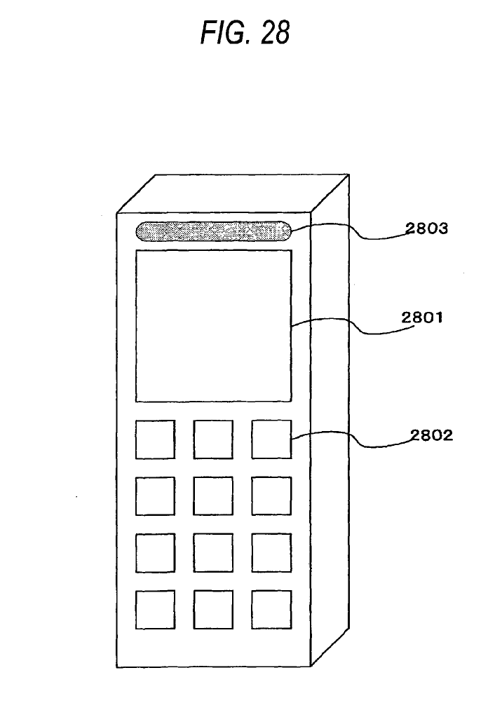

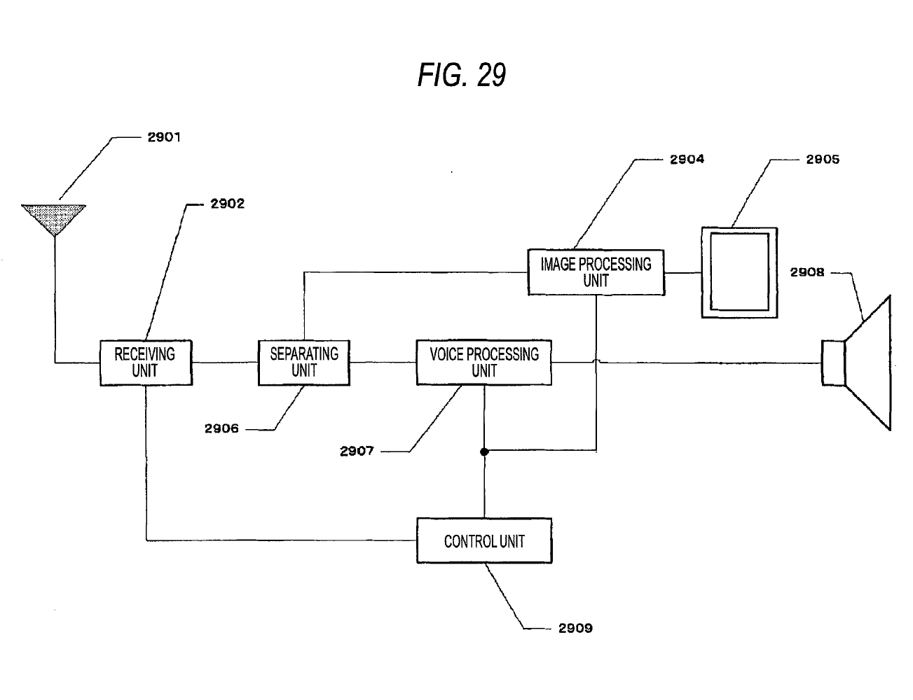

FIG. 28 is a block diagram for indicating a broadcast receiving terminal according to a ninth embodiment mode of the present invention. As indicated in FIG. 28, the broadcast receiving terminal of the ninth embodiment mode is equipped with an image display unit 2801, a key 2802, and a speaker 2803. FIG. 29 is a block diagram for representing an internal arrangement of the broadcast receiving terminal of the ninth embodiment mode. As shown in FIG. 29, the broadcast receiving terminal of the ninth embodiment mode is equipped with an antenna 2901, a receiving unit 2902, an image processing unit 2904, an image display unit 2905, a separating unit 2906, a voice processing unit 2907, a speaker 2908, and a control unit 2909.

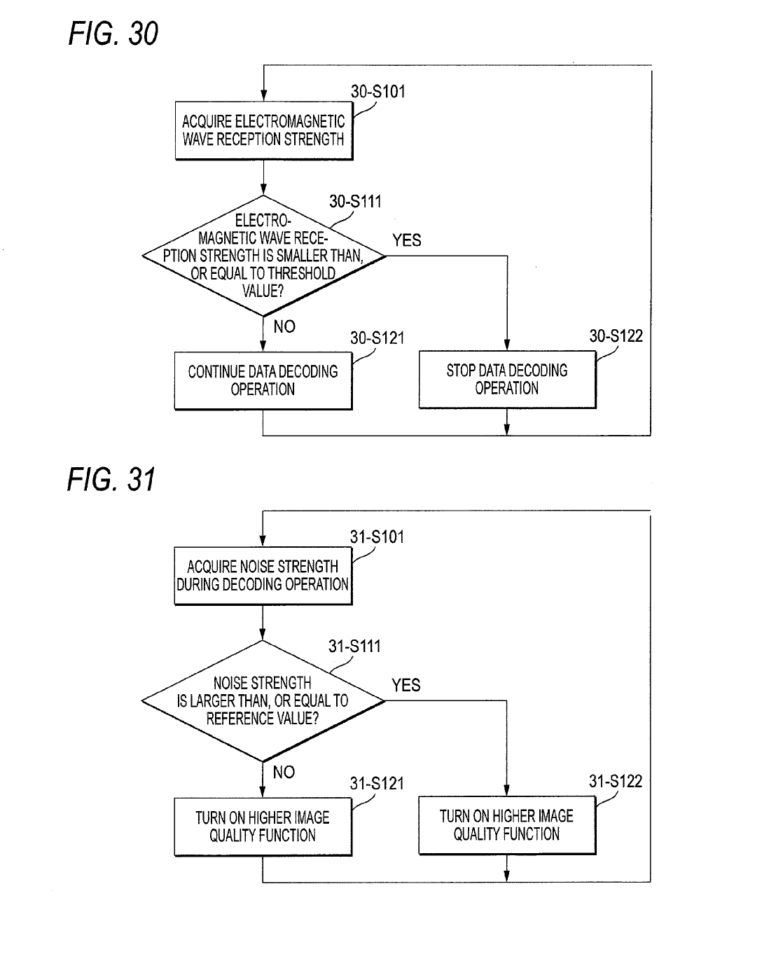

FIG. 30 is a flow chart for describing operations of the broadcast receiving terminal of the ninth embodiment mode. As shown in FIG. 30, the control unit 2909 detects an electromagnetic wave reception signal strength of a wireless signal which is received by the receiving unit 2902 (step 30-S101), and then, turns ON, or OFF both an image processing operation and a voice processing operation (both processing operations will be combined to be referred as “data decoding process operation” hereinafter) in response to this detected electromagnetic wave reception signal strength (step 30-S111). In the case that the electromagnetic reception signal strength is larger than, or equal to a reference value, the control unit 2909 executes the data decoding process operation (step 30-S121). On the other hand, in the case that the electromagnetic reception signal strength is smaller than the reference value, the control unit 2909 stops the data decoding process operation (step 30-S122). It should also be understood that the above-explained process operations executed by the control unit 2909 may be alternatively realized by employing software.

### Tenth Embodiment Mode

A broadcast receiving terminal according to a tenth embodiment mode of the present invention has the same arrangement as that of the broadcast receiving terminal indicated in FIG. 28, or FIG. 29. FIG. 31 is a flow chart for describing operations of the broadcast receiving terminal of the tenth embodiment mode. As shown in FIG. 31, the control unit 2909 detects a situation of an error during decoding process operation, namely detects a noise strength (step 31-S101), and then switches the image process operations in response to this detected noise strength (step 31-S111). In the case that the noise strength is higher than, or equal to a reference value, the control unit 2909 turns OFF the higher image quality function (step 31-S122). On the other hand, in the case that the noise strength is lower than the reference value, the control unit 2909 turns ON the higher image quality function (step 31-S121). It should also be understood that the above-explained process operations executed by the control unit 2909 may be alternatively realized by employing software.

### Eleventh Embodiment Mode

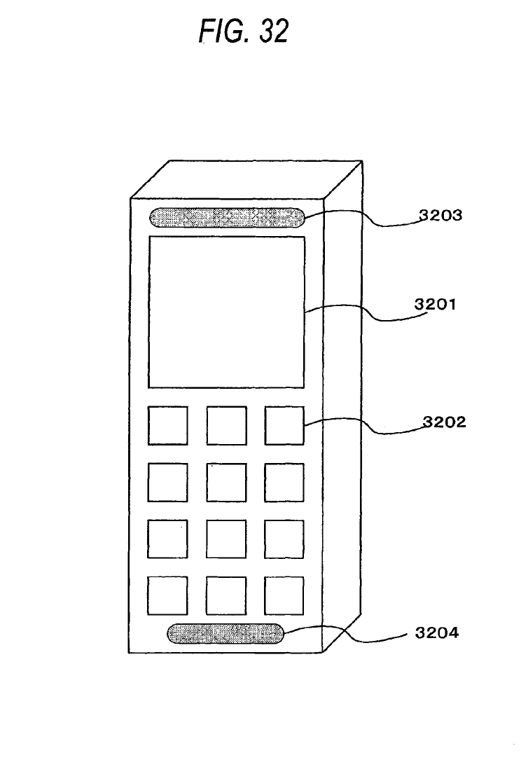

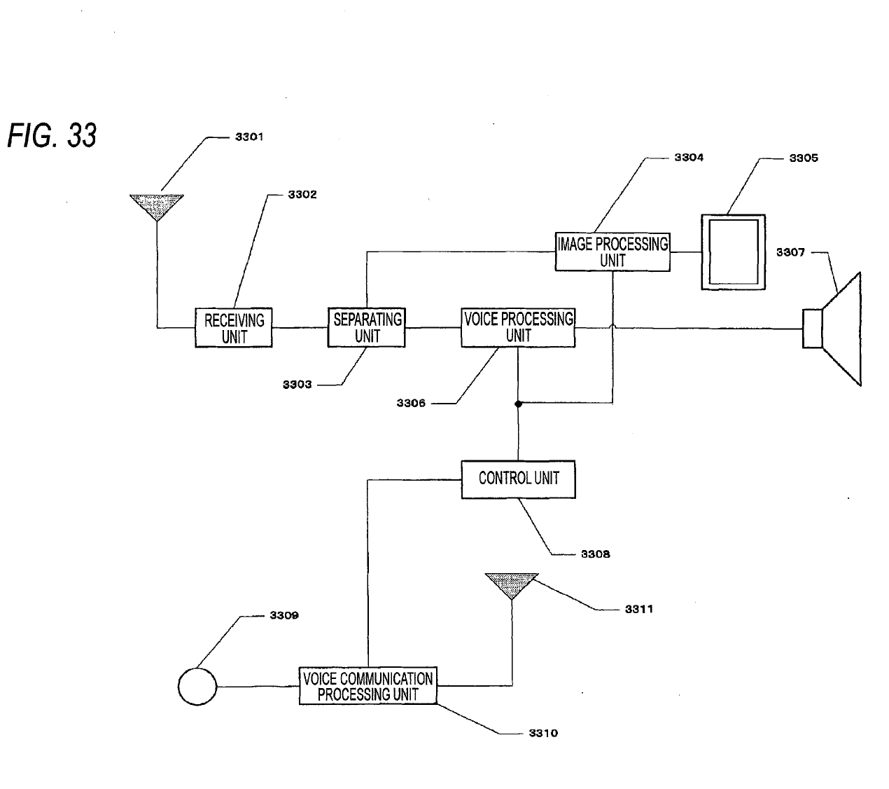

FIG. 32 is a block diagram for showing a broadcast receiving terminal according to an eleventh embodiment mode of the present invention. As represented in FIG. 32 the broadcast receiving terminal of the eleventh embodiment mode is equipped with an image display unit 3201, a key 3202, a speaker 3203, and a microphone 3204. FIG. 33 is a block diagram for representing an internal arrangement of the broadcast receiving terminal of the eleventh embodiment mode. As represented in FIG. 33, the broadcast receiving terminal of the eleventh embodiment mode is equipped with an antenna 3301, a receiving unit 3302, a separating unit 3303, a voice processing unit 3306, a speaker 3307, an image processing unit 3304, an image display unit 3305, a control unit 3308, a microphone 3309, a voice communication processing unit 3310, and a telephone communication-purpose antenna 3311.

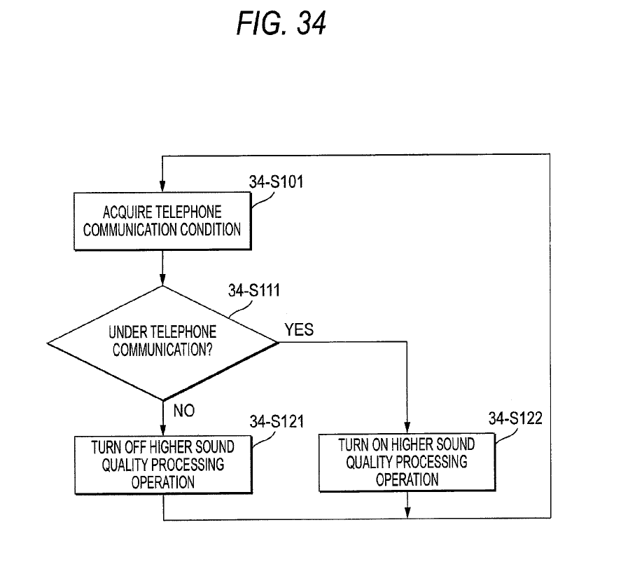

FIG. 34 is a flow chart for describing operations of the broadcast receiving terminal of the eleventh embodiment mode. As shown in FIG. 34, the control unit 3408 detects a telephone communication condition (step 34-S101), and then switches voice processing operations in response to the detected telephone communication condition (step 34-S111). In such a case that the user is under telephone communication, the control unit 3309 turns OFF the higher sound quality function (step 34-S121). On the other hand, in such a case that the user is not under telephone communication, the control unit 3309 turns ON the higher sound quality function (step 34-S122). It should also be understood that the above-explained process operations executed by the control unit 3408 may be alternatively realized by employing software.

As previously described, in accordance with the above-explained broadcast receiving terminals of the first embodiment mode through the eleventh embodiment mode, such a condition is detected under which the execution effects as to the higher sound quality process operations and the higher image quality process operations are low, and thus, the useless higher sound quality process operation and the useless high image quality process operation can be reduced. As a consequence, even when the switching instruction is not issued from the user, the broadcast receiving terminals can select the optimum operation mode in response to the situations in order that the power consumption thereof can be suppressed.

It should further be understood that although the present embodiment modes have exemplified such broadcast receiving terminals capable of receiving the television broadcasting programs based upon the “1seg” service, broadcast receiving terminals capable of receiving digital radio programs may be alternatively realized.

The electronic appliances related to the present invention are useful as broadcast receiving terminals and the like, which automatically perform power control operations.

What is claimed is:

1. An electronic appliance, comprising:
a voice processing unit executing one voice processing operation selected from plural sorts of voice processing operations;
a zapping detecting unit detecting a zapping condition; and
a process switching unit switching the presently executed voice processing operation to a different voice processing operation in response to a detection result for indicating whether or not said zapping condition is detected; wherein:
when said zapping detecting unit detects the zapping condition, said process switching unit controls said voice processing unit to switch the presently executed voice processing operation to a voice processing operation which does not contain a sound quality improving function.

2. An electronic appliance comprising:
an image processing unit executing one image processing operation selected from plural sorts of image processing operations;
a zapping detecting unit detecting a zapping condition; and
a process switching unit switching the presently executed image processing operation to a different image processing operation in response to a detection result for indicating whether or not said zapping condition is detected; wherein:
when said zapping detecting unit detects the zapping condition, said process switching unit controls said image processing unit to switch the presently executed image processing operation to an image processing operation which does not contain an image quality improving function.

3. An electronic appliance comprising:
a voice processing unit executing one voice processing operation selected from plural sorts of voice processing operations a judging unit judging whether a signal transmission path defined from said voice processing unit up to a voice output unit corresponds to a wired signal transmission path, or a wireless signal transmission path; and
a process switching unit switching the presently executed voice processing operation to a different voice processing operation in response to a judgement result of said signal transmission path; wherein:
when said signal transmission path is the wired signal transmission path, said process switching unit controls said voice processing unit to switch the presently executed voice processing operation to a voice processing operation which contains a sound quality improving function, whereas
when said signal transmission path is the wireless signal transmission path, said process switching unit controls said voice processing unit to switch the presently executed voice processing operation to a voice processing operation which does not contain said sound quality improving function.

4. An electronic appliance comprising:
a voice processing unit executing one voice processing operation selected from plural sorts of voice processing operations;
an information acquiring unit acquiring genre information about contents which are processed by said voice processing unit; and
a process switching unit switching the presently executed voice processing operation to a different voice processing operation in response to the genre information acquired by said information processing unit; wherein:
said plural sorts of voice processing operations include a voice processing operation which contains a sound quality improving function, and another voice processing operation which does not contain the sound quality improving function.

5. An electronic appliance comprising:
a voice processing unit executing one voice processing operation selected from plural sorts of voice processing operations;
a sound volume measuring unit measuring a surrounding sound volume; and
a process switching unit switching the presently executed voice processing operation in response to information related to the surrounding sound volume measured by said sound volume measuring unit, wherein
when said measured surrounding sound volume is lower than a reference value, said process switching unit controls said voice processing unit to switch the presently executed voice processing operation to a voice processing operation which contains a sound quality improving function.

6. An electronic appliance comprising:
an image processing unit executing one image processing operation selected from plural sorts of image processing operations;
a luminance detecting unit detecting surrounding luminance; and
a process switching unit switching the presently executed image processing operation to a different image processing operation in response to information related to the surrounding luminance detected by said luminance detecting unit; wherein:
when said detected surrounding luminance is lower than a reference value, said process switching unit controls said image processing unit to switch the presently executed image processing operation to an image processing operation which contains an image quality improving function.

7. An electronic appliance comprising:
a key operating unit;
an image processing unit executing one image processing operation selected from plural sorts of image processing operations;
a key operation detecting unit detecting a time interval of key input operations with respect to said key operating unit; and
a process switching unit switching the presently executed image processing operation to a different image processing operation in response to the time interval of the key input operations detected by said key operation detecting unit; wherein:
when said detected time interval of the key input operations is longer than, or equal to a reference value, said process switching unit controls said image processing unit to switch the presently executed image processing operation to an image processing operation which contains an image quality improving function.

8. An electronic appliance comprising:
two housings which can be opened and closed with each other;
an image processing unit executing one image processing operation selected from plural sorts of image processing operations;
a condition detecting unit detecting open/close conditions of said two housings; and
a process switching unit switching the presently executed image processing operation to a different image processing operation in response to a condition detected by said condition detecting unit; wherein:
when said two housings are under open condition, said process switching unit controls said image processing unit to switch the presently executed image processing operation to an image processing operation which contains an image quality improving function.

9. An electronic appliance comprising:
a voice processing unit executing one voice processing operation-selected from plural sorts of voice processing operations;
a data broadcast processing unit executing a processing operation in order to display a data broadcasting content; and
a process switching unit switching the presently executed voice process operation to a different voice process operation in response to a situation for indicating whether or not said data broadcast processing unit performs said digital broadcasting content display processing operation; wherein:
when said data broadcast processing unit does not execute said digital broadcasting content display processing operation, said process switching unit controls said voice processing unit to switch the presently executed voice processing operation to a voice processing operation which contains a sound quality improving function.

10. An electronic appliance comprising:
a receiving unit for receiving a wireless signal;
a reception strength detecting unit detecting an electromagnetic wave reception strength of a wireless signal received by said receiving unit;
an image processing unit executing an image processing operation;
a voice processing unit executing a voice processing operation; and
a process switching unit switching said image processing operation and said sound processing operation in response to an electromagnetic wave reception strength detected by said reception strength detecting unit; wherein:
when the electromagnetic wave reception strength detected by said reception strength detecting unit is larger than, or equal to a reference value, said process switching unit controls both said image processing unit and said voice processing unit so as to execute both said image processing operation and said voice processing operation.

11. An electronic appliance comprising:
an image processing unit executing one image processing operation selected from plural sorts of image processing operations;
a noise detecting unit detecting a noise strength indicative of a situation of an error occurred when a decoding operation is carried out by said image processing unit; and
a process switching unit switching the presently executed image process operation: to a different image processing operation in response to a noise strength detected by said noise detecting unit; wherein:
when the noise strength detected by said noise: detecting unit is smaller than a reference value, said process switching unit controls said image processing unit to switch the presently executed image processing operation to an image processing operation which contains an image quality improving function.

12. An electronic appliance comprising:
a voice communication processing unit performing a voice communication processing operation by utilizing a wireless signal;
a voice processing unit executing one voice processing operation selected from plural sorts of voice processing operations; and
a process switching unit switching the presently executed voice processing operation to a different voice processing operation in response to a situation for indicating whether or not said voice communication processing unit performs said voice communication processing operation; wherein:
when said voice communication processing unit does not perform said voice communication processing operation, said process switching unit controls said voice processing unit to switch the presently executed voice processing operation to a voice processing operation which contains a sound quality improving function.

13. A process switching program for causing a computer to function as the respective units comprised in the electronic appliance recited in any one of claim 1 to claim 12.
